(19) United States
(12) Patent Application Publication
(10) Pub. No.: US 2023/0096644 A1
(43) Pub. Date: Mar. 30, 2023

(54) COIL COMPONENT

(71) Applicant: Murata Manufacturing Co., Ltd., Kyoto-fu (JP)

(72) Inventors: Masayuki OISHI, Nagaokakyo-shi (JP); Takashi SAKAI, Nagaokakyo-shi (JP); Makoto YAMAMOTO, Nagaokakyo-shi (JP)

(73) Assignee: Murata Manufacturing Co., Ltd., Kyoto-fu (JP)

(21) Appl. No.: 17/932,939

(22) Filed: Sep. 16, 2022

(30) Foreign Application Priority Data
Sep. 29, 2021 (JP) 2021-159269

(51) Int. Cl. H01F 27/32; H01F 27/29; H01F 41/12

(52) U.S. Cl. CPC H01F 27/323; H01F 27/29; H01F 41/122

(57) ABSTRACT

A coil component includes a multilayer body including a plurality of insulating layers and a plurality of coil conductor layers which are stacked in a stacking direction, and a first via conductor and a second via conductor that electrically connect the coil conductor layers. The first via conductor is smaller than the second via conductor.

### CROSS-REFERENCE TO RELATED APPLICATION

This application claims benefit of priority to Japanese Patent Application No. 2021-159269, filed Sep. 29, 2021, the entire content of which is incorporated herein by reference.

### BACKGROUND

### Technical Field

The present disclosure relates to a coil component.

### Background Art

In recent years, since there is a trend for higher-current electronic devices, coil components have become required to have a higher rated current. For example, Japanese Unexamined Patent Application Publication No. 2008-053368, Japanese Unexamined Patent Application Publication No. 8-130115, and Japanese Unexamined Utility Model Registration Application Publication No. 5-57817 each disclose a coil component in which a plurality of (for example, two) sheets having a coil conductor formed thereon are stacked together and connected in parallel via through holes, and sheets connected in parallel are connected in series.

### SUMMARY

As a larger number of sheets having a coil conductor formed thereon are stacked in order to obtain desired coil characteristics, stress between the insulating layer and the coil conductor increases. As a result, there is a concern that cracks may occur. Furthermore, it is necessary to increase the amount of a conductive material to be supplied to the through holes that electrically connect coil conductors. The use amount of the conductive material thus increases, resulting in an increase in material cost.

Accordingly, the present disclosure provides a coil component in which the use amount of a conductive material for connecting coil conductors is reduced, and good coil characteristics can be obtained.

A coil component according to the present disclosure includes a multilayer body including a plurality of insulating layers and a plurality of coil conductor layers which are stacked in a stacking direction, and a first via conductor and a second via conductor that electrically connect the coil conductor layers, in which the first via conductor is smaller than the second via conductor.

According to the coil component of the present disclosure, the use amount of the conductive material used for the first via conductor and the second via conductor that electrically connect the coil conductor layers is reduced, and good coil characteristics can be obtained.

### BRIEF DESCRIPTION OF THE DRAWINGS

FIG. 1 is a perspective view of a coil component of the present disclosure;

FIG. 2 is an exploded perspective view of a multilayer body of a coil component according to a first embodiment;

FIG. 3 is a plan view of stack members constituting the multilayer body in the coil component according to the first embodiment;

FIG. 4 is a cross-sectional view taken along the line IV-IV in FIG. 2, viewed in the arrow direction;

FIG. 5 is an enlarged cross-sectional view of a portion surrounded by the broken line in FIG. 4;

FIG. 6A is a schematic cross-sectional view illustrating an insulating layer formation step, FIG. 6B is a schematic cross-sectional view illustrating a step of producing a resin paste for formation of a gap portion, FIG. 6C is a schematic cross-sectional view illustrating a coil conductor layer formation step, FIG. 6D is a schematic cross-sectional view illustrating a step of arranging an insulating material around the coil conductor layer, and FIG. 6E is a schematic cross-sectional view illustrating a multilayer body production step;

FIG. 7A is a plan view of a stack member constituting the multilayer body, and FIG. 7B is a cross-sectional view taken along the line b-b in FIG. 7A, viewed in the arrow direction;

FIG. 8A is a plan view of a stack member constituting the multilayer body, and FIG. 8B is a cross-sectional view taken along the line b-b in FIG. 8A, viewed in the arrow direction;

FIG. 9 is a plan view of stack members constituting a multilayer body in a coil component according to a second embodiment;

FIG. 10 is a cross-sectional view of the coil component according to the second embodiment;

FIG. 11 is a plan view of stack members constituting a multilayer body in a coil component according to a third embodiment; and

FIG. 12 is a cross-sectional view of the coil component according to the third embodiment.

### DETAILED DESCRIPTION

Coil components of the present disclosure will be described in detail below. Although descriptions will be made with reference to the drawings as necessary, the contents shown in the drawings are merely schematic and illustrative to facilitate understanding of the present disclosure, and appearances, scale ratios, and the like can differ from real ones. Note that the structures of coil components described here are merely illustrative and do not limit the disclosure.

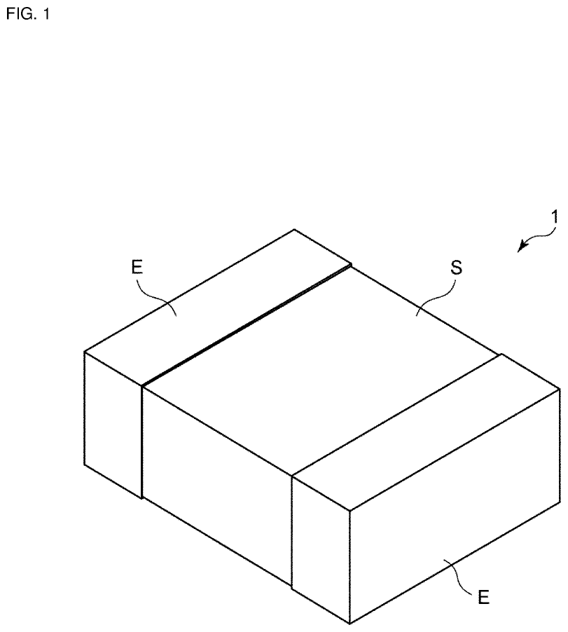

A coil component 1 includes, as shown in FIG. 1, a multilayer body S and outer electrodes E. The multilayer body S has a substantially rectangular parallelepiped shape and may have a coil built therein. The outer electrodes E are each electrically connected to the coil, extend in the stacking direction, and may be provided on side surfaces opposed to each other of the multilayer body S. Coil components according to first to third embodiments of the present disclosure will be described below.

[Coil Component According to First Embodiment]

A coil component 1 of the present disclosure includes a multilayer body S including a plurality of insulating layers I and a plurality of coil conductor layers M which are stacked in a stacking direction, and a first via conductor FV and a second via conductor SV which electrically connect the coil conductor layers M.

First, stack members sb1 to sb16 constituting the multilayer body S will be described. The number of stack members stacked is not limited to 16 although an example including 16 stack members is described.

The stack members sb1 and sb16 disposed at outermost surfaces each cover a coil conductor layer M, which will be described later, and may include an insulating layer I. The insulating layer I may be formed of preferably a magnetic material, and more preferably a sintered ferrite. The insulating layer I may contain, as main components, at least Fe, Zn, Cu, and Ni. For example, the content of Fe in terms of Fe₂O₃ may be 40.0 mol % or more and 49.5 mol % or less (i.e., from 40.0 mol % to 49.5 mol %), the content of Zn in terms of ZnO may be 2 mol % or more and 35 mol % or less (i.e., from 2 mol % to 35 mol %), the content of Cu in terms of CuO may be 6 mol % or more and 13 mol % or less (i.e., from 6 mol % to 13 mol %), and the content of Ni in terms of NiO may be 10 mol % or more and 45 mol % or less (i.e., from 10 mol % to 45 mol %). The insulating layer I may further contain an additive, such as Co, Bi, Sn, or Mn, or impurities that are inevitable in production.

The stack members sb2 to sb15 disposed at the inner sides of the stack members sb1 and sb16 disposed at outermost surfaces may each include the insulating layer I, the coil conductor layer M, and a via conductor V.

The conductive material constituting the coil conductor layer M is not particularly limited, but for example, may be Au, Ag, Cu, Pd, or Ni. The conductive material may be preferably Ag or Cu, and more preferably Ag. The conductive materials may be used alone or in combination of two or more. The coil conductor layer M is formed into a shape, such as a U shape, in which end portions are not connected to each other, (i.e., a shape of an unclosed coil conductor layer), and the coil conductor layer M may be formed on the insulating layer I.

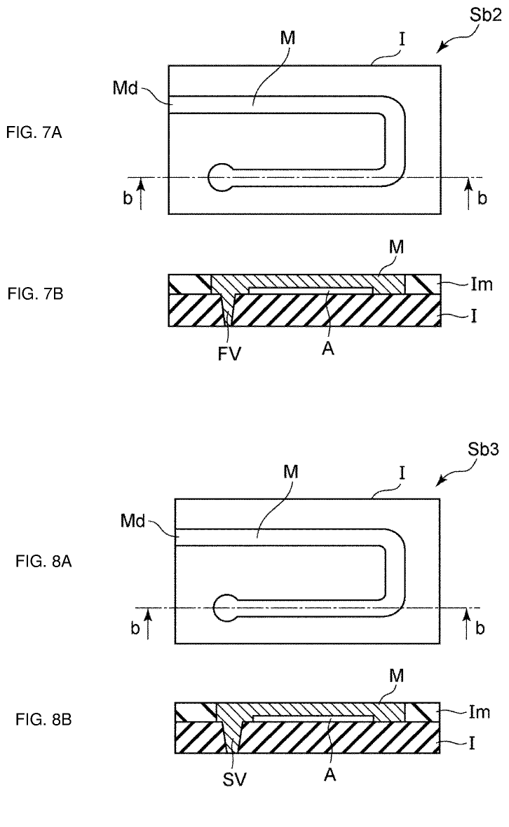

The thickness of the coil conductor layer M is determined depending on the rated current passed through the coil component. In the case where a high current is passed, the thickness of the coil conductor layer M is preferably 20 μm or more and 100 μm or less (i.e., from 20 μm to 100 μm). By increasing the thickness of the coil conductor layer M, the resistance value of the coil component decreases. Here, when the thickness of the coil conductor layer M increases, the protruding amount of the coil conductor layer M from the surface of the insulating layer I increases, and there is a possibility that strain may occur at the time when the multilayer body S is produced by stacking the stack members sb1 to sb16. In order to reduce the strain, by placing an insulating material Im around the coil conductor layer M, the protruding amount of the coil conductor layer M may be reduced (refer to FIG. 7B and FIG. 8B). Note that in the case where the thickness of the coil conductor layer M is relatively small and the strain is small when the multilayer body S is produced, it is not always required to form the insulating material Im around the coil conductor layer M.

From the viewpoint of production, the via conductor V is preferably formed using the same material as that of the coil conductor layer M. However, a different material from that of the coil conductor layer M may be used. The via conductor V may include a first via conductor FV and a second via conductor SV that electrically connect the coil conductor layers M. The first via conductor FV may be smaller than the second via conductor SV. In other words, the amount of the conductive material used for the first via conductor FV may be smaller than the amount of the conductive material used for the second via conductor SV. That is, in the present specification, the term “the first via conductor FV being smaller than the second via conductor SV” is intended to refer to the magnitude relationship based on the volume of the via conductor. Accordingly, in the coil component 1 of the present disclosure, since the first via conductor FV is smaller than the second via conductor SV, the amount of the conductive material used for the via conductor can be reduced compared with a coil component 1 in which coil conductor layers M are electrically connected by the second via conductor SV only.

Optionally, the stack members sb1 to sb16 may be configured such that a gap portion A is provided between the coil conductor layer M and the insulating layer I. The gap portion A functions as a so-called stress relief space. That is, when the temperature decreases to room temperature after the multilayer body S has been fired, because of a difference in coefficient of linear expansion between the coil conductor layer M and the insulating layer I, stress is produced between the coil conductor layer M and the insulating layer I. This stress can be relieved by the gap portion A. The thickness of the gap portion A is preferably 1 μm or more. By setting the thickness of the gap portion A to be 1 μm or more, internal stress can be further relieved, and the occurrence of cracks can be effectively suppressed.

A multilayer body S in which the stack members sb1 to sb16 are stacked will now be described.

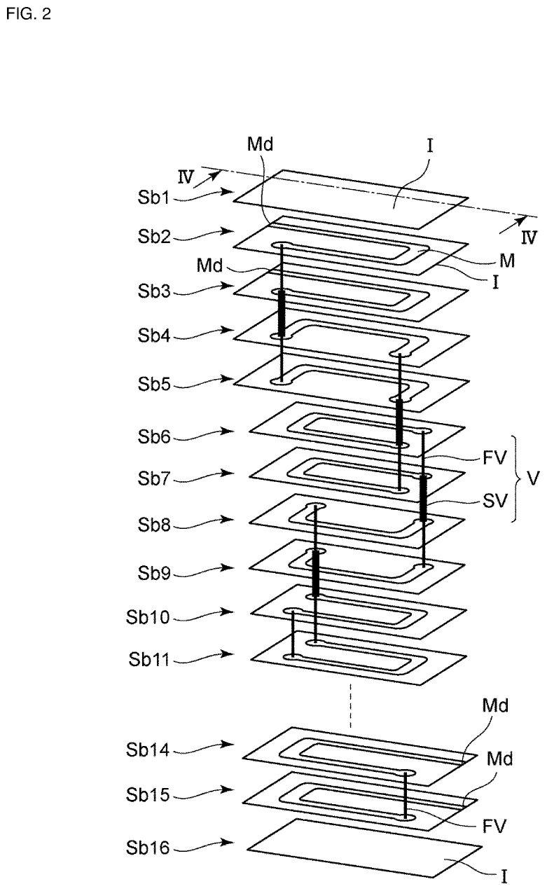

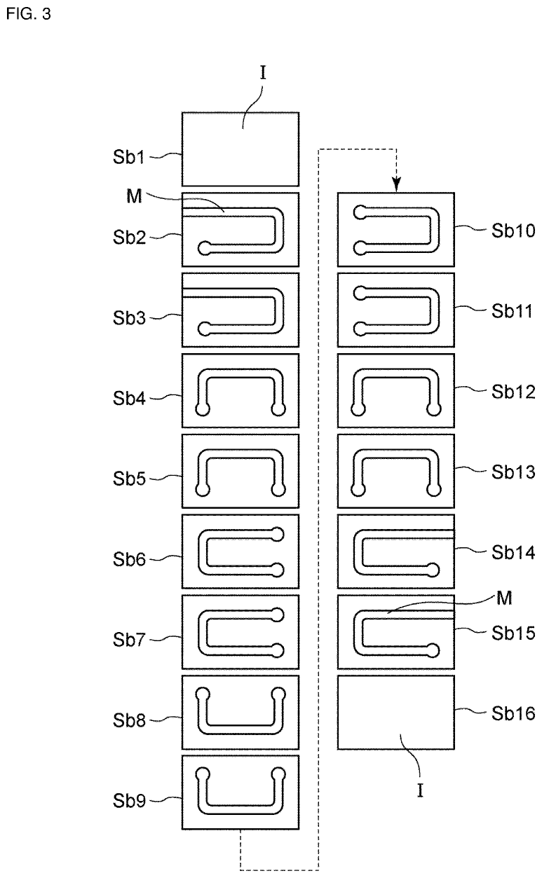

In the multilayer body S of the coil component 1 of the present disclosure, the coil conductor layers M that are adjacent to each other in the stacking direction may be electrically connected in parallel using a first via conductor FV (refer to FIG. 2 and FIG. 3). In the present specification, the term “connected in parallel” is intended to refer to a configuration in which each of two ends of the coil conductor layer M is electrically connected to the coil conductor layer adjacent thereto in the stacking direction. In one example, as shown in FIG. 2 and FIG. 3, in the stack member sb2 second from the top in the stacking direction and the stack member sb3 third from the top, one ends of the coil conductor layers M are electrically connected to each other through the outer electrode E, and the other ends are electrically connected to each other through a first via conductor FV. Furthermore, in one example, in the stack member sb4 fourth from the top in the stacking direction and the stack member sb5 fifth from the top, two ends of the coil conductor layers M are electrically connected to each other through first via conductors FV. Although an embodiment in which two adjacent stack members are connected in parallel is shown in the drawings, three or more stack members may be connected in parallel.

In the multilayer body S of the coil component 1 of the present disclosure, the coil conductor layers M that are adjacent to each other in the stacking direction may be electrically connected in series using a second via conductor SV (refer to FIG. 2 and FIG. 3). In the present specification, the term “connected in series” is intended to refer to a configuration in which one of two ends of the coil conductor layer M is electrically connected to the coil conductor layer adjacent thereto in the stacking direction. In one example, as shown in FIG. 2 and FIG. 3, in the stack member sb3 third from the top in the stacking direction and the stack member sb4 fourth from the top, one ends of the coil conductor layers M are electrically connected to each other through a second via conductor SV, but the other ends of the coil conductor layers M are not electrically connected to each other. The same applies to the stack member sb5 fifth from the top in the stacking direction and the stack member sb6 sixth from the top.

In the case where the coil component 1 of the present disclosure is used for high current application, by connecting coil conductor layers M in parallel, it is possible to pass a current to the same extent as in the case where the apparent thickness of a coil conductor layer M is increased. When the coil conductor layers connected in parallel are electrically connected in series, desired coil characteristics can be obtained. Here, the current flowing through the first via conductor FV used for parallel connection is smaller than the current flowing through the second via conductor SV used for series connection. Therefore, even if the first via conductor FV is made smaller than the second via conductor SV, the influence on the electrical characteristics of the coil component is small. Consequently, it is possible to provide a coil component in which good electrical characteristics can be obtained even when the amount of the conductive material used for the via conductor is reduced.

In a preferred embodiment of the coil component 1, the coil conductor layers M connected by the first via conductor FV may have the same shape, and the coil conductor layers M connected by the second via conductor SV may have different shapes. In one example, as shown in FIG. 2 and FIG. 3, the coil conductor layer M of the second stack member sb2 and the coil conductor layer M of the third stack member sb3 which are connected by the first via conductor FV have the same shape, and the coil conductor layer M of the third stack member sb3 and the coil conductor layer M of the fourth stack member sb4 which are connected by the second via conductor SV have different shapes. In the present specification, the term “same shape” is intended to refer to a state in which, when coil conductor layers M are viewed in perspective in the stacking direction, the coil conductor layers M substantially overlap each other, and the term “different shapes” is intended to refer to a state in which, when coil conductor layers M are viewed in perspective in the stacking direction, the coil conductor layers M substantially do not overlap each other. In the coil component of the present disclosure, the coil conductor layers M having the same shape are electrically connected by the first via conductor FV, and the coil conductor layers M having different shapes are electrically connected by the second via conductor SV. Therefore, in the coil component, the amount of the conductive material used for the via conductor can be reduced, and good electrical characteristics can be obtained.

In a preferred embodiment of the coil component 1, adjacent coil conductor layers M which are located on the outermost side of the multilayer body S may be each provided with an extended portion Md electrically connected to an outer electrode E (refer to FIG. 2). In the configuration of the extended portions Md of the present disclosure, since the outer electrode E is electrically connected with the extended portions Md provided on adjacent coil conductor layers, even if malfunction occurs in one extended portion Md, electrical connection can be secured with the other extended portion Md.

Furthermore, regarding the extended portions Md, the coil conductor layers M provided with the extended portions Md may be electrically connected to each other by a first via conductor FV. In such a configuration, the coil conductor layers M provided with the extended portions Md are connected in parallel by the extended portions Md together with the outer electrode E. Consequently, since the coil conductor layers M are connected to each other using the first via conductor FV in which the use amount of the conductive material is small, in the coil component, the use amount of the conductive material can be reduced, and good electrical characteristics can be obtained.

A referred embodiment of the first via conductor FV and the second via conductor SV will now be described.

In a preferred via conductor, the first via conductor FV and the second via conductor SV may be arranged in the same straight line. By arranging the via conductor in such a manner, coil conductor layers M can be electrically connected to each other by a simple method without a complex step.

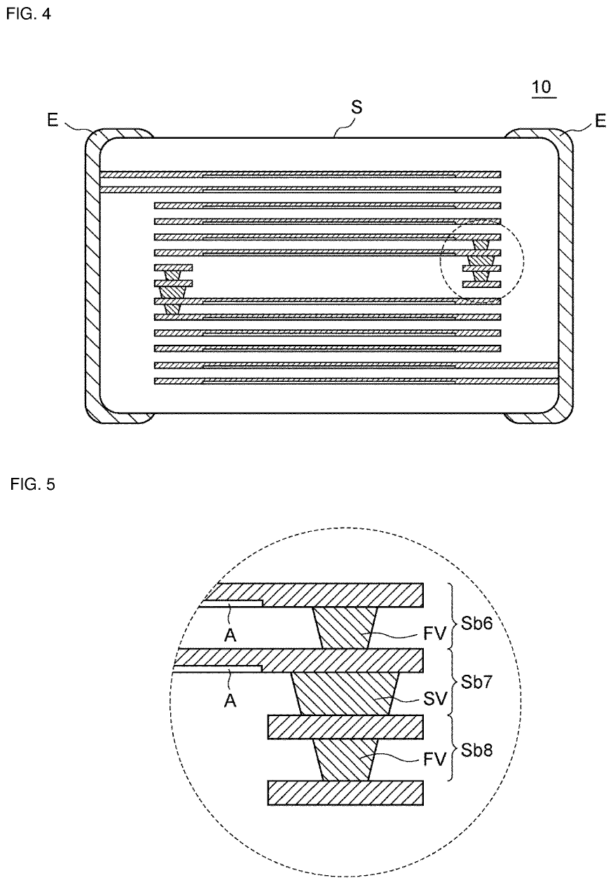

In a preferred shape of the via conductor, in cross-sectional view, the first via conductor FV and the second via conductor SV may have a taper shape which widens in the stacking direction (refer to FIG. 4 and FIG. 5). By forming the via conductor in a taper shape, a conductive material can be easily supplied from the wider side.

Furthermore, in cross-sectional view, the smallest width of the first via conductor may be 0.5 or more times and less than 0.75 times (i.e., from 0.5 times to less than 0.75 times) the smallest width of the second via conductor. Grounds for the numerical values will be described later in Examples.

[Method for Manufacturing Coil Component According to First Embodiment]

A method for manufacturing a coil component according to a first embodiment will now be described. The method for manufacturing a coil component includes an insulating layer formation step, a via conductor formation step, a coil conductor layer formation step, and a multilayer body production step.

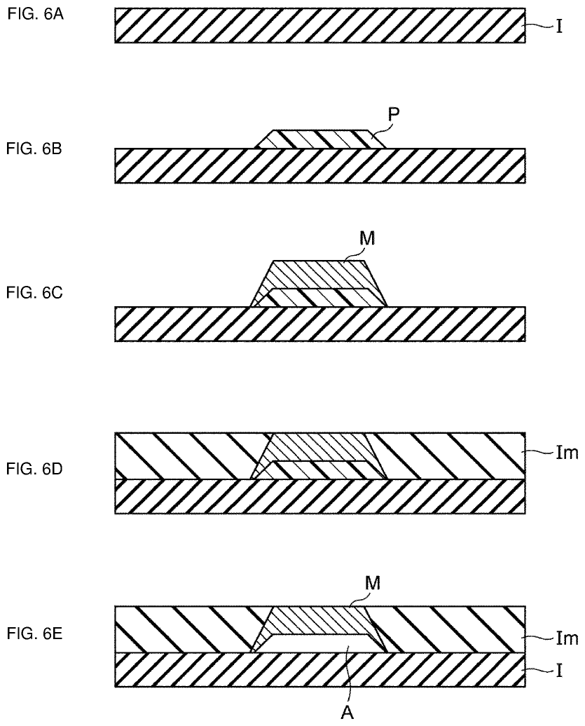

—Insulating Layer Formation Step (Refer to FIG. 6A)—

First, as starting materials, Fe₂O₃, ZnO, CuO, and NiO are weighed so as to satisfy the predetermined composition described above. The starting materials, together with pure water and PSZ (partially stabilized zirconia) balls, are placed in a ball mill, and wet mixing and pulverization are performed for 4 hours or more and 8 hours or less (i.e., from 4 hours to 8 hours). Subsequently, after water is evaporated to dryness, calcination is performed at a temperature of 700° C. or higher and 800° C. or lower (i.e., from 700° C. to 800° C.) for 2 hours or more and 5 hours or less (i.e., from 2 hours to 5 hours), to thereby obtain a calcined product (calcined powder).

The resulting calcined product, together with PSZ media, is placed in a ball mill, and furthermore a polyvinyl butyral-based organic binder, an organic solvent such as ethanol or toluene, and a plasticizer are placed therein, followed by mixing. The resulting mixture is formed into a sheet with a thickness of 20 μm or more and 30 μm or less (i.e., from 20 μm to 30 μm) using a doctor blade process or the like, and the sheet is punched out into a rectangular shape, thereby forming a sheet-shaped insulating layer I.

—Via Conductor Formation Step—

A through hole is formed in the resulting sheet-shaped insulating layer I by irradiating a predetermined portion thereof with laser. In the case where a through hole is formed by laser irradiation, the shape of the through hole may be a taper shape tapering from the laser-irradiated surface which is wide. Note that the formation of the through hole is not limited to by laser irradiation, and another processing technique that can form a through hole may be employed. As the through hole, a through hole for forming a second via conductor SV and a through hole for forming a first via conductor FV that is smaller than the second via conductor SV are formed.

Although not an essential step in the method for manufacturing a coil component, after the via conductor formation step, optionally, a resin paste P for formation of a gap portion may be produced and applied by printing to the insulating layer I (refer to FIG. 6B). The resin paste P for formation of a gap portion may be produced, for example, by dissolving a resin that vanishes during firing (e.g., an acrylic resin) in a solvent (isophorone or the like). In order to prevent a gap portion A from being exposed to the outer surface of the multilayer body S, the resin paste P for formation of a gap portion is not applied to the position of the extended portion Md that is connected to the outer electrode E.

—Coil Conductor Layer Formation Step (Refer to FIG. 6C)—

First, a conductive material is prepared. The conductive material is, for example, Au, Ag, Cu, Pd and/or Ni, and is preferably Ag or Cu, and more preferably Ag. A predetermined amount of powder of the conductive material is weighed, and the powder, predetermined amounts of a solvent (eugenol or the like), a resin (ethyl cellulose or the like), and a dispersant are kneaded with a planetary mixer or the like, followed by dispersion with a triple roll mill or the like. Thus, a conductive paste can be produced.

The conductive paste is applied by printing to the insulating layer I so as to be formed into a predetermined shape of a coil conductor layer M. In the manufacturing method shown in FIG. 6C, the coil conductor layer M is formed so as to cover the resin paste P for formation of a gap portion. That is, in plan view, the area of the coil conductor layer M is preferably larger than the area of the resin paste P for formation of a gap portion. Note that the formation method of the conductive paste is not limited to printing, but may be coating or the like.

Although not an essential step in the method for manufacturing a coil component, in the case where the thickness of the coil conductor layer M is large, strain occurs during stacking, and therefore, in order to improve strain, a step of placing an insulating material Im around the coil conductor layer M may be optionally carried out (refer to FIG. 6D). The insulating material Im can be produced by kneading, with a planetary mixer or the like, a starting material obtained by pulverizing a ferrite starting material (calcined product) having a predetermined composition into a predetermined particle size, with a ketone-based solvent, a resin such as polyvinyl acetal, and a plasticizer such as an alkyd-based plasticizer, followed by dispersion with a triple roll mill or the like. The resulting insulating material Im may be applied by printing so as to surround the coil conductor layer M. Note that in the case where the thickness of the coil conductor layer M is small to such an extent that the strain during stacking is small, this step may be omitted.

—Multilayer Body Production Step (FIG. 6E)—

The stack members sb1 to sb16 formed by the procedure described above are stacked in a predetermined order (for example, refer to FIG. 2 and FIG. 3) and subjected to thermal pressure bonding, thereby producing a multilayer body block. After the multilayer body block is singulated, firing is performed in a firing furnace at a temperature of 900° C. or higher and 920° C. (i.e., from 900° C. to 920° C.) or lower for 2 hours or more and 4 hours or less (i.e., from 2 hours to 4 hours). In this process, in the case where the resin paste P for formation of a gap portion is applied, the resin paste P for formation of a gap portion is vanished by firing to form a gap portion A. Then, as an optional step, the fired multilayer body is placed in a rotating barrel machine and corner portions thereof are rounded.

A conductive paste for forming outer electrodes E is applied to the multilayer body S produced as described above, and baking is performed under the conditions of 800° C. or higher and 820° C. or lower (i.e., from 800° C. to 820° C.) to form underlying electrodes. Then, a Ni film and a Sn film are formed in this order by electrolytic plating. Thus, a desired coil component 1 can be produced.

[Coil Component According to Second Embodiment]

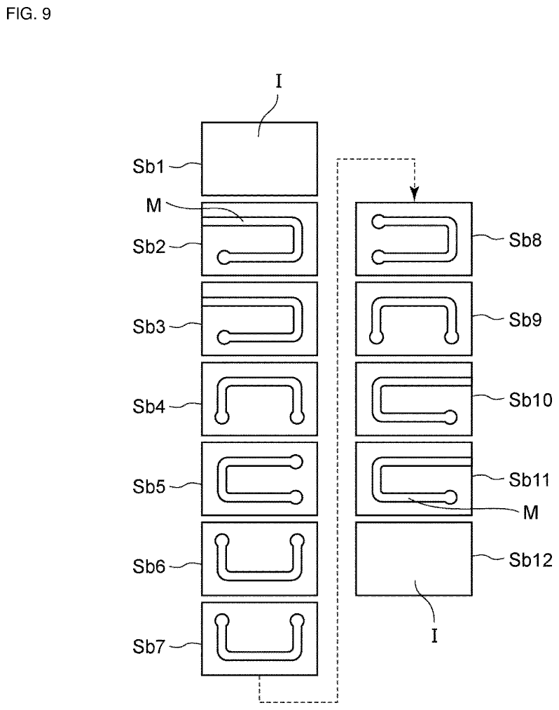

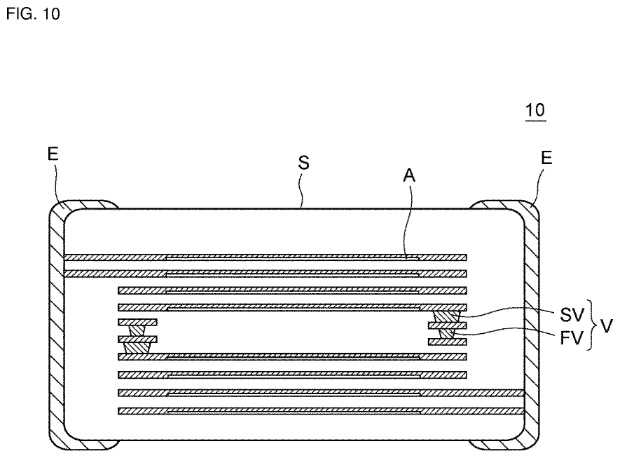

A coil component according to a second embodiment will now be described with reference to FIG. 9 and FIG. 10. Descriptions that are duplicate of those made above are appropriately omitted.

In the coil component according to the first embodiment, adjacent coil conductor layers M are connected in parallel. From the viewpoint of the rated current flowing through the coil component, the coil component according to the second embodiment may include a portion which does not include a parallel connection. In other words, in a coil component 1 according to the second embodiment, a multilayer body S may include a portion in which coil conductor layers are electrically connected in series continuously in the stacking direction.

As illustrated in FIG. 9, for example, the stack member sb3 and the stack member sb4 which are adjacent to each other are connected in series, and the stack member sb4 and the stack member sb5 which are adjacent to each other are also connected in series. In this embodiment also, the via conductor that makes electrical series connection may be a second via conductor SV, and the via conductor that makes electrical parallel connection may be a first via conductor FV.

In such a configuration, a coil component can be appropriately designed so that a predetermined rated current can flow therethrough.

[Coil Component According to Third Embodiment]

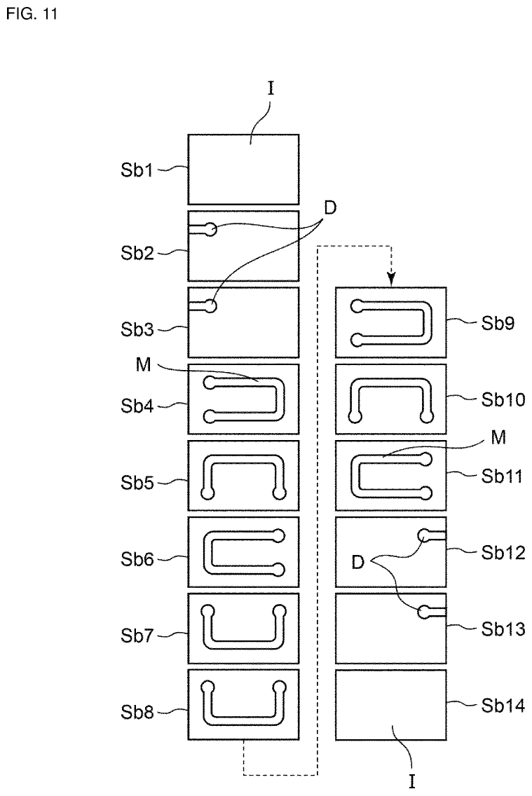

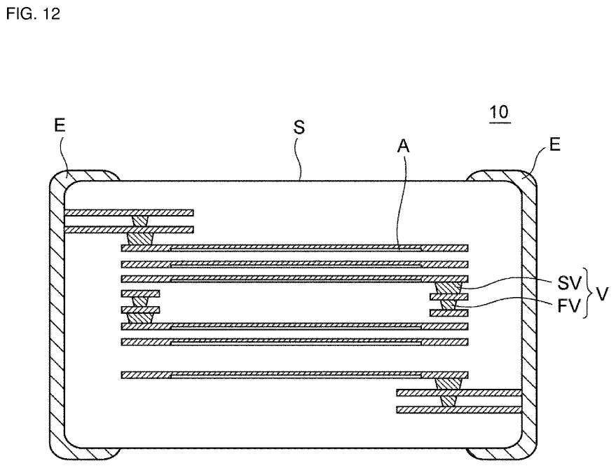

A coil component according to a third embodiment will now be described with reference to FIG. 11 and FIG. 12. Descriptions that are duplicate of those made above are appropriately omitted.

In the coil component according to the first embodiment, adjacent coil conductor layers M which are located on the outermost side of the multilayer body S are each provided with an extended portion Md electrically connected to an outer electrode E. In the coil component according to the third embodiment, at least two extended electrode layers D which are electrically connected to an outer electrode E may be provided so as to be adjacent to each other on the outer side in the stacking direction of the coil conductor layers M.

The extended electrode layers D may have a non-bent shape instead of a bent shape that constitutes a coil. In other words, the extended electrode layers D may function as interconnection layers used to electrically connect the adjacent coil conductor layers M to the outer electrode E.

In a preferred embodiment of the extended electrode layers D, two extended electrode layers D may be provided so as to be adjacent to each other. In such a configuration, even if malfunction occurs in one extended electrode layer D, electrical connection can be secured with the other extended electrode layer D.

In the coil component according to the third embodiment, since electrical connection to the outer electrode E is made by the extended electrode layers D which are different from the coil conductor layers M, freedom of layout (position, size, and the like) of the extended electrode layers D can be improved.

In a preferred embodiment of extended electrode layers D, the extended electrode layers D may be electrically connected to each other by a first via conductor FV. That is, the extended electrode layers D are connected in parallel to each other by the first via conductor FV together with the outer electrode E. Consequently, since the connection is made using the first via conductor FV in which the use amount of the conductive material is small, in the coil component, the use amount of the conductive material can be reduced, and good electrical characteristics can be obtained.

Furthermore, the extended electrode layer D and the coil conductor layer M may be electrically connected by a second via conductor SV. That is, the extended electrode layer D and the coil conductor layer M may be connected in series. In such a configuration, desired coil characteristics as the coil component can be obtained.

### Examples

A verification test was carried out on “coil components” according to the present disclosure. Specifically, a 1.5-turn coil component was produced by connecting in series two coil conductor layers, each coil conductor layer including coil conductors with a thickness of 12 μm and a width of 110 μm connected in parallel (i.e., with respect to the coil component shown in FIG. 2 and FIG. 3, stack members sb1 to sb3 were connected in series to stack members sb14 to sb16). Regarding the size of each of the first via conductor FV and the second via conductor SV, the smallest width was as shown in [Table 1]. Furthermore, the ratio based on the width of the first via conductor FV to the second via conductor SV was as shown in [Table 1]. DC resistance was measured for each coil component produced. The DC resistance measurement results are shown in Table 1.

TABLE 1

| Sample No. | 1 | | 2 | 3 | 4 |
|---|---|---|---|---|---|
| Width of | 36 | μm | 27 μm | 18 μm | 9 μm |
| first via conductor | | | | | |
| Width of | 36 | μm | 36 μm | 36 μm | 36 μm |
| second via conductor | | | | | |
| Ratio | 1 | | 0.75 | 0.50 | 0.25 |
| DC resistance | 0.025 | Ω | Less than +5% | Less than +5% | +5% or more |
| | | | relative to | relative to | relative to |
| | | | Sample No. 1 | Sample No. 1 | Sample No. 1 |
| | | | (∘) | (∘) | (Δ) |

| | | | | |
|---|---|---|---|---|
| Presence or absence | Present | Present | Absent | Absent |
| of cracks | (x) | (x) | (∘) | (∘) |
| in via conductor | | | | |

Regarding the evaluation method of the width of the via conductor, a cross section in which the first via conductor and the second via conductor were exposed was FIB-machined using a focused ion beam machining device (SMI3050R of SII Nano Technology Inc.), and by subjecting the cross section to SEM observation, the smallest width of each of the first via conductor and the second via conductor was calculated.

Regarding the DC resistance, using a digital resistance meter 755611 manufactured by Yokogawa Electric Corporation, the resistance value at a measurement current of 10 mA was measured.

Regarding the presence or absence of cracks in the via conductor, when 100 pieces for each sample were produced, whether cracks occurred or not in the first via conductor or the second via conductor was confirmed by the SEM observation.

[Table 1] above shows that regarding the DC resistance of the coil component, in Sample No. 2 and Sample No. 3, the increase in the resistance value was less than 5%, and good coil characteristics were obtained. Furthermore, in Sample No. 1 and Sample No. 2, since the first via conductor FV and the second via conductor SV were large, stress between the coil conductor layer M and the insulating layer I increased, resulting in occurrence of cracks and the like. Consequently, the result of the verification test shows that the smallest width of the first via conductor is preferably 0.5 or more times and less than 0.75 times (i.e., from 0.5 times to less than 0.75 times) the smallest width of the second via conductor.

It should be considered that the embodiments disclosed this time are illustrative and non-restrictive in all aspects. Therefore, the technical scope of the present disclosure is construed not only by the embodiments described above but is defined by the appended claims. Furthermore, the technical scope of the present disclosure includes all modifications within the meaning and scope equivalent to those of the claims.

Multilayer coil components of the present disclosure can be used, as inductors and the like, widely in various applications.

What is claimed is:

1. A coil component comprising:
a multilayer body including a plurality of insulating layers and a plurality of coil conductor layers which are stacked in a stacking direction, and a first via conductor and a second via conductor that electrically connect the coil conductor layers,
wherein the first via conductor is smaller than the second via conductor.

2. The coil component according to claim 1, wherein
the first via conductor is a via conductor which electrically connects in parallel coil conductor layers that are adjacent to each other in the stacking direction, and
the second via conductor is a via conductor which electrically connects in series coil conductor layers that are adjacent to each other in the stacking direction.

3. The coil component according to claim 1, wherein
the coil conductor layers connected by the first via conductor have the same shape, and
the coil conductor layers connected by the second via conductor have different shapes.

4. The coil component according to claim 1, wherein
the first via conductor and the second via conductor are arranged in the same straight line.

5. The coil component according to claim 1, wherein
in cross-sectional view, the first via conductor and the second via conductor have a taper shape which widens in the stacking direction.

6. The coil component according to claim 1, wherein
in cross-sectional view, the smallest width of the first via conductor is from 0.5 times to less than 0.75 times the smallest width of the second via conductor.

7. The coil component according to claim 1, wherein
adjacent coil conductor layers which are located on the outermost side of the multilayer body each has an extended portion electrically connected to an outer electrode.

8. The coil component according to claim 7, wherein
the coil conductor layers having the extended portions are electrically connected to each other by the first via conductor.

9. The coil component according to claim 1, wherein
at least two extended electrode layers which are electrically connected to an outer electrode are adjacent to each other on the outer side of the coil conductor layers.

10. The coil component according to claim 9, wherein
the extended electrode layers are electrically connected to each other by the first via conductor.

11. The coil component according to claim 9, wherein
the extended electrode layer and the coil conductor layer are electrically connected by the second via conductor.

12. The coil component according to claim 1, wherein
a gap portion is between the coil conductor layer and the insulating layer.

13. The coil component according to claim 2, wherein
the coil conductor layers connected by the first via conductor have the same shape, and
the coil conductor layers connected by the second via conductor have different shapes.

14. The coil component according to claim 2, wherein
the first via conductor and the second via conductor are arranged in the same straight line.

15. The coil component according to claim 2, wherein
in cross-sectional view, the first via conductor and the second via conductor have a taper shape which widens in the stacking direction.

16. The coil component according to claim 2, wherein
in cross-sectional view, the smallest width of the first via conductor is from 0.5 times to less than 0.75 times the smallest width of the second via conductor.

17. The coil component according to claim 2, wherein
adjacent coil conductor layers which are located on the outermost side of the multilayer body each has an extended portion electrically connected to an outer electrode.

18. The coil component according to claim 2, wherein
at least two extended electrode layers which are electrically connected to an outer electrode are adjacent to each other on the outer side of the coil conductor layers.

19. The coil component according to claim 10, wherein
the extended electrode layer and the coil conductor layer are electrically connected by the second via conductor.

20. The coil component according to claim 2, wherein
a gap portion is between the coil conductor layer and the insulating layer.
